(19) United States
(12) Patent Application Publication
(10) Pub. No.: US 2008/0250071 A1
(43) Pub. Date: Oct. 9, 2008

(54) SYSTEMS AND METHODS FOR BUSINESS APPLICATIONS

(75) Inventors: Jan-Michael Norring, Sammamish, WA (US); Kalpana Narayanaswamy, Redmond, WA (US); David G. Bettin, Snoqualmie, WA (US)

Correspondence Address: BLACK LOWE & GRAHAM, PLLC, 701 FIFTH AVENUE, SUITE 4800, SEATTLE, WA, 98104, US

(73) Assignee: SynerG Software Corporation, Kirkland, WA (US)

(21) Appl. No.: 12/099,060

(22) Filed: Apr. 7, 2008

Related U.S. Application Data
(60) Provisional application No. 60/910,564, filed on Apr. 6, 2007.

(51) Int. Cl. G06F 17/30

(52) U.S. Cl. 707/104.1; 707/E17.009

(57) ABSTRACT

A system and method for developing business application meta-objects which are application building blocks that access information from multiple information stores and nay be assembled in different combinations to service different business communities. The meta-objects permit business applications to be constructed and revised on the fly by an end-user. The business application development platform follows a model-driven approach to create business application meta-objects where each meta-object encapsulates the behavior, information and visual components. The application meta-objects may be modified by the end user without underlying development of the software code and may operate with multiple data and business logic stores. In one embodiment, the system supports a variety of post development tools permitting the end user to create, update and customize a number of aspects of the business applications, and in particular the way the data is viewed.

### PRIORITY

This application claims priority to U.S. Provisional Patent Application No. 60/910,564 filed on Apr. 6, 2007, the subject matter of which is incorporated herein by reference in its entirety.

### FIELD OF THE INVENTION

The present invention generally pertains to enterprise business applications, and more specifically to enterprise business applications developed as reusable application meta-objects (building blocks for applications) that can be created, controlled, customized and combined by an end-user to create one or more business applications.

### BACKGROUND OF THE INVENTION

Many businesses have customers, vendors and others that generally require some level of service support. With customers for example, the service support may be in the form of customer service that requires access to multiple pieces of information—customer data accounting data, inventory data, shipping and receiving data, and so on. In most customer service centers a business agent access this information by working with multiple business applications. The agent must often spend time mentally sorting through duplicative or erroneous data and spend time entering data multiple times to access information from the various data sources. For example, the agent may enter the customer's name to access customer accounting data, switch to an order system to look up the order information there, switch to a customer relationship management (CRM) system to update sales data, and then switch one more time to access a trouble shooting system to initiate a query requested by the customer. The continual switching generates inefficiencies and costs on a variety of levels. The same inefficiencies occur in other business functions such as sales, procurement, marketing, and so on due to the need to work with multiple monolithic siloed business applications to complete a task.

One proposed solution to the above-noted problem involves a process known as “screen scraping,” where a virtual screen is constructed and data from the multiple data sources may be copied from the virtual screen into a user interface. One drawback with this proposed solution is that it requires custom coding at the developmental level for each situation and changes can be expensive in both time and money to implement.

In the past decade, various steps have been taken to move away from a monolithic, tightly coupled business application. The monolithic approach made data, business logic, and user interface all part of the same application stack typically causing each component to be dependent upon another. This type of business application served a specific function well, but not the needs of the business user who needs to interact with multiple functions.

The adoption of service oriented architecture (SOA) is one initiative taking place in the industry today for building composite business applications. Application silos containing duplicated data and logic catering to a specific function of the business are now made available as business services that are reusable and standards-based across different business functions.

While SOA is changing the way enterprises allow access to business data and business logic, the static approach to building business applications for business users using hardwired user interfaces created specifically for each of the business user groups does not effectively scale to meet the demands of the modern business user.

Business applications require their user interfaces and business rules to be extensible as the requirements vary from one business function to another and from one end user to another. The conventional approach to composite business application development consists of writing software code to construct and handle the behavior of the user interface and the interaction with the data and business logic. One disadvantage of this approach is that the application, after construction, may be static and brittle in terms of handling changes and revisions. Also, to serve different user functions, individual applications have to be created to display the same information in the different formats as required by the business function.

Further, making changes to an application built with the conventional approach described above requires new code development, compilation, testing and deployment. Once the software is deployed to users subsequent revisions also require a full software development cycle. Another drawback is that all the components that make up the business application, are dependent on one another in a one-to-one relationship. Thus, revising one of the components triggers a full software development cycle, even if there are no changes to the user interface through which the users interact.

In recent years there has been shift in application development techniques in that the monolithic business application with model-driven architectures creating an application with loosely coupled software components. This approach makes the application more adaptive to changes and downstream revisions. While this approach delivers flexibility in breaking down and insulating the components to make revisions easier, limitations remain such as, but not limited to, a tight coupling of the application behavior with specific business functions. Further, this approach still requires code development and testing before the changes are available to the business user.

### SUMMARY OF THE INVENTION

According to at least one embodiment, the present invention provides a system and method for constructing business applications through a higher level encapsulation of application concepts defined as application meta-objects. These meta-objects are application building blocks that can be combined in different ways to create different business applications for different business roles. The invention further allows the ability for developer-level revisions to be made to the business applications by an end-user of the business application in a controlled, non-destructive fashion. The business application is layered upon or otherwise cooperates with the enterprise data source systems as a model-driven application meta-object software application using a declarative based language. The result is a composite business application made up of reusable application meta-objects where the same meta-objects can be combined and customized in different ways to deliver to the specific needs of a business user. Further, with this invention, the application may be developed (e.g., modified, revised, manipulated, etc.) by the end-user without writing new software code and may operate with multiple data and business logic stores. In addition, the composite business application supports a variety of post development revisions to the business application that does require software code development such that non-development professionals (i.e., end-users) are able to create, update and customize a number of aspects of the business applications. The extent to which the end-user may create, update and customize the business application may be restricted with permissions encoded in the model-driven application meta-objects. The system and method provide a business application platform on which real-time changes may be made while the application is in use and the changes can be rolled out immediately to a community of users without going through the conventional development, test, and launch steps currently required and undertaken at a developer level to make such changes to existing business applications.

In one aspect of the invention, a business application is broken down into discrete units of function that make up the business application, such as customer information, order information and so on. The discrete units provide a taxonomy of application functions required by all business users as application meta-objects. In one embodiment, the application meta-objects capture the relevant information pertaining to the business function, the actions that can be performed on the information, the physical location of the information in one or more enterprise systems, the security rules governing the information and the possible visualizations or user interfaces supported in viewing and transacting with the information. The application meta-objects may be seen as a collection of cooperating objects that have the end-to-end information associated with a business function—location of data, security, business rules, and user interface all defined in a declarative based language, as opposed to the traditional business application where the information is not contained in a reusable fashion. Each meta-object is capable of receiving messages, processing data, and sending messages to other meta-objects. Each meta-object can be viewed as an independent little machine representing a distinct business function.

The meta-objects can then be combined in different combinations to service a specific business user needs. The meta-objects define a clear list of permitted actions they allow and this in turn restricts the business user to only valid possible combinations—ensuring user actions do not break the application or jeopardize the integrity of the business data. Further the user is capable of setting the visualization or the type of user interface to view and act upon this information giving the user complete control on customization of the application to suit their needs. With this approach, the entire enterprise application needs are broken down into meta-application objects, where the same meta-object can be combined in different ways to serve different communities of business users. The traditional approach of creating static hard-coded applications for each business user group is now replaced by an innovative business application platform that services the needs of all business users in a declarative model-driven software application. End-users have the ability to partake in the creation and modification of the application at a developer-level, the same information can be represented to different users with different visualizations, and all actions in the system may be constrained to only permitted actions. The system further becomes adaptable with ongoing use and becomes a self-learning platform through the pattern of behavior of the business user.

In another aspect of the invention, a business application platform includes a display system and a front-end business application environment having a page viewable on the display system. The platform further includes a plurality of application meta-objects arrangeable to form the page, each meta-object with a customizable user interface and logic for communication with a back-end data source systems environment to receive data accessible by a plurality of data source systems. The data represented in the page may be arranged in a custom layout scheme on each meta-object. A plurality of model-driven application meta-objects are disposed between the front-end business application environment and the back-end data source systems environment. The plurality of model-driven application meta-objects are configured to process an amount of meta-data according to a set of rules, wherein at least some of the meta-data is reconfigurable by a viewer of the display system through a viewer-accessible design menu. The design menu is operable by the viewer to customize the first presentation layout into a viewer-desired presentation layout. In addition, a processor controls the data exchanged from the back-end data source systems environment through the model-driven application meta-objects to the front-end business application environment.

In yet another aspect of the invention, a method of displaying a user interface for a business application to an end-user includes the steps of (1) accessing data from back-end systems environment; (2) processing the data using a plurality of model-driven application meta-objects in data communication with the back-end data source environment and a front-end user interface environment; (3) transmitting the processed data to a front-end user interface environment of the business application; and (4) selectively arranging the plurality of application meta-objects viewable on the front-end user interface environment using a design menu accessible by the end user, each application meta-object having an amount of data retrievable from the back-end data source systems environment, wherein selectively arranging the plurality of application meta-objects includes customizing a viewable display of the plurality of application meta-objects to meet a specific need of the end-user without re-designing, re-testing, and re-deploying the business application at a developer level.

As will be readily appreciated from the foregoing summary, the invention provides systems and methods for building and developing model driven business applications that are adaptable during usage to obtain or otherwise access desired information and logic from multiple data systems and allow an end-user to make what are currently developer-level revisions to meet changing business needs, strategies, and demands and to achieve a customized presentational layout of the end-user's display interface. In one embodiment, the system and methods allow for creation of domain specific composite applications using the declarative based platforms. In yet another embodiment, the business applications utilized by the end-user may be adaptable to become more intelligent through self-learning based modules that track and process end-user trends and business usage while providing more functionality, efficiency and improved data access.

### BRIEF DESCRIPTION OF THE DRAWINGS

The preferred and alternative embodiments of the present invention are described in detail below with reference to the following drawings:

FIG. 1 is a block diagram showing a computer, various computer peripherals, and various communication means for the computer according to an embodiment of the invention;

FIG. 2 is a schematic diagram showing an interactive business application ecosystem having an interface module in communication with two or more data stores or silos through a service oriented architecture system according to an embodiment of the invention;

FIG. 3 is a diagram showing a business application platform having a data and logic federator that combines data and business logic from multiple data sources according to an embodiment of the invention;

FIG. 4 is a diagram of a business application system having multiple interfaces and an enterprise systems interface according to an embodiment of the invention; and

FIG. 5 is a flow diagram showing a method for accessing data from multiple data sources and selectively arranging a user interface in which the data is presented according to an embodiment of the invention.

### DETAILED DESCRIPTION OF THE PREFERRED EMBODIMENT

In the following description, certain specific details are set forth in order to provide a thorough understanding of various embodiments of the invention. In other instances, well-known structures and methods associated with software application, development, and software building techniques and systems, and methods of accessing data using business applications may not be shown or described in detail to avoid unnecessarily obscuring descriptions of the embodiments of the invention.

The following description generally relates to systems and methods for employing model-driven application architecture to create an adaptive business application where data may be integrated from among a collection of application or systems. In one embodiment, the adaptive business application is constructed from re-usable model-driven application meta-objects. An environment for the application, which may include by way of example a computer having a user-interface, a personal data assistant (PDA), a digital pen and paper system, or other equivalent digital processing system, allows revisions to be made during usage of the application and deployed to a user community without any unwanted latency, log, or delay.

For many businesses today, it is imperative for business users to access cross-functional business data to accomplish their work. Organizations allow access in one of two ways—the business user uses a specific application to access each discrete function of information or the organization develops a custom application to service cross-functional data, typically one for each business function—sales, call center and so on. The inefficiencies surrounding the above mentioned approaches is removed with this invention where a unified business application platform can be used to access cross-functional business data in a way that can be reused to create different user experiences for different user groups without the need to create a specific business application for each business role.

The invention further empowers end-users of business applications to design and customize the business information presented to them on their interface and permits the end-users to react quickly to rapidly changing business needs, which may, in the aggregate, permit the business to gain a competitive edge over competitors. By way of example, businesses receive customer and vendor inquiries all the time. A customer, for example, may call to obtain billing information about a product they own. The customer may also have a few questions about the status of a product accessory recently ordered and may further have one or more technical questions regarding the operation or functionality of the product. In one embodiment, the present invention permits end-users, for example the people receiving the customer or vendor inquiries, to design, revise and employ a user interface for one or more business applications in real time to more efficiently and effectively obtain desired information that would previously have been accessible only through separate and distinct platforms.

For example, the hypothetical customer mentioned above would, using existing technology, have to contact the billing department to obtain billing information, then be transferred to the shipping department to obtain information on their new purchase and then be transferred to the technical department for their technical questions. During each transfer, the end-user would ask for the same information (name, account no., etc., for example) because the end-user would be using a static business application with a fixed layout for the presentation of data or information and with access to only certain data stores, which may not and are likely not the same data stores accessed by the other departments of the business. Accordingly, one aspect of the present invention permits business applications to be quickly adapted through direction of the end-user to incorporate changes which are optimized for the business via process flows and customized interfaces.

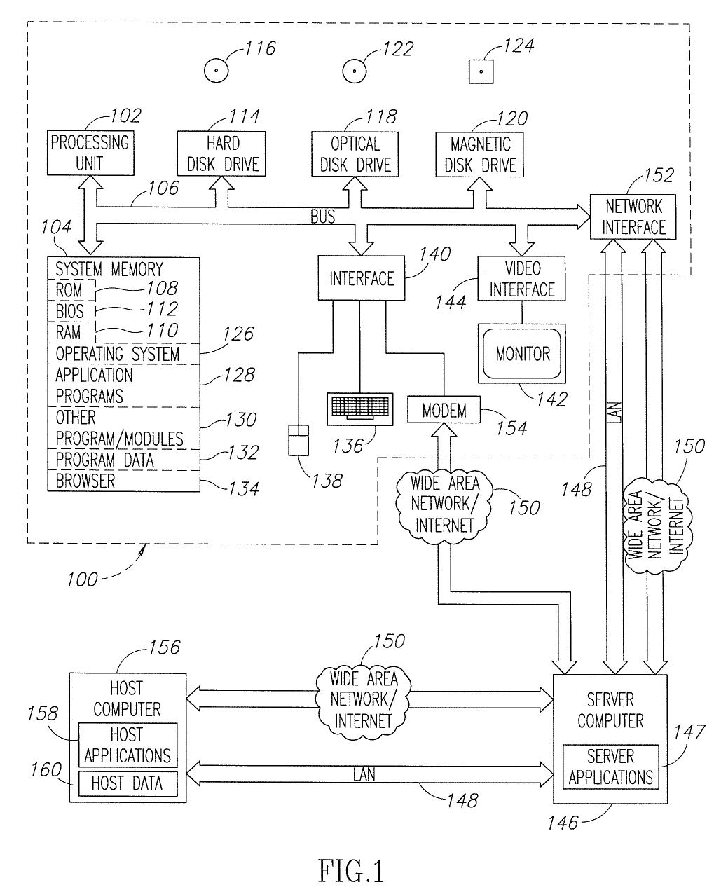

FIG. 1 in cooperation with the following provides a general description of a computing environment that may be used to implement various aspects of the present invention. For purposes of brevity and clarity, embodiments of the invention may be described in the general context of computer-executable instructions, such as program application modules, objects, applications, models, or macros being executed by a computer, which may include but is not limited to personal computer systems, hand-held devices, multiprocessor systems, microprocessor-based or programmable consumer electronics, network PCs, mini computers, mainframe computers, and other equivalent computing and processing sub-systems and systems. Aspects of the invention may be practiced in distributed computing environments where tasks or modules are performed by remote processing devices linked through a communications network. Various program modules, data stores, repositories, models, federators, objects, and their equivalents may be located in both local and remote memory storage devices.

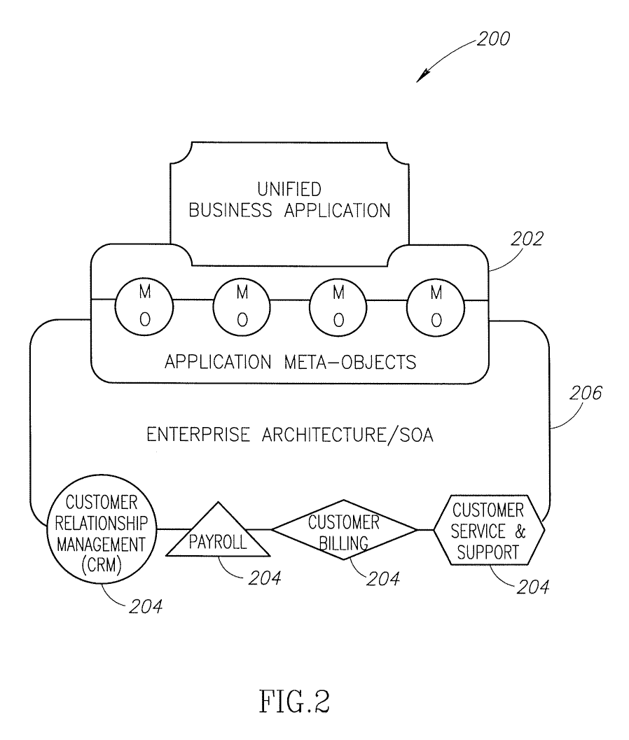

By way of example, a conventional personal computer, referred to herein as a computer 100, includes a processing unit 102, a system memory 104, and a system bus 106 that couples various system components including the system memory to the processing unit. The computer 100 will at times be referred to in the singular herein, but this is not intended to limit the application of the invention to a single computer since, in typical embodiments, there will be more than one computer or other device involved. The processing unit 102 may be any logic processing unit, such as one or more central processing units (CPUs), digital signal processors (DSPs), application-specific integrated circuits (ASICs), etc. Unless described otherwise, the construction and operation of the various blocks shown in FIG. 2 are of conventional design. As a result, such blocks need not be described in further detail herein, as they will be understood by those skilled in the relevant art.

The system bus 106 can employ any known bus structures or architectures, including a memory bus with memory controller, a peripheral bus, and a local bus. The system memory 104 includes read-only memory (“ROM”) 108 and random access memory (“RAM”) 110. A basic input/output system (“BIOS”) 112, which can form part of the ROM 108, contains basic routines that help transfer information between elements within the computer 100, such as during start-up.

The computer 100 also includes a hard disk drive 114 for reading from and writing to a hard disk 116, and an optical disk drive 118 and a magnetic disk drive 120 for reading from and writing to removable optical disks 122 and magnetic disks 124, respectively. The optical disk 122 can be a CD-ROM, while the magnetic disk 124 can be a magnetic floppy disk or diskette. The hard disk drive 114, optical disk drive 118, and magnetic disk drive 120 communicate with the processing unit 102 via the bus 106. The hard disk drive 114, optical disk drive 118, and magnetic disk drive 120 may include interfaces or controllers (not shown) coupled between such drives and the bus 106, as is known by those skilled in the relevant art. The drives 114, 118, 120, and their associated computer-readable media, provide nonvolatile storage of computer readable instructions, data structures, program modules, and other data for the computer 100. Although the depicted computer 100 employs hard disk 116, optical disk 122, and magnetic disk 124, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 104, such as an operating system 126, one or more application programs 128, other programs or modules 130 and program data 132. The system memory 104 also includes a browser 134 for permitting the computer 100 to access and exchange data with sources such as web sites of the Internet, corporate intranets, or other networks as described below, as well as other server applications on server computers such as those further discussed below. The browser 134 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. Although the depicted embodiment shows the computer 10 as a personal computer, in other embodiments, the computer is some other computer-related device such as a personal data assistant (PDA), a cell phone, or other mobile device.

The operating system 126 may be stored in the system memory 104, as shown, while application programs 128, other programs/modules 130, program data 132, and browser 134 can be stored on the hard disk 116 of the hard disk drive 114, the optical disk 122 of the optical disk drive 118, and/or the magnetic disk 124 of the magnetic disk drive 120. A user can enter commands and information into the computer 1000 through input devices such as a keyboard 136 and a pointing device such as a mouse 138. Other input devices can include a microphone, joystick, game pad, scanner, etc. These and other input devices are connected to the processing unit 102 through an interface 140 such as a serial port interface that couples to the bus 106, although other interfaces such as a parallel port, a game port, a wireless interface, or a universal serial bus (“USB”) can be used. A monitor 142 or other display device is coupled to the bus 106 via a video interface 144, such as a video adapter. The computer 100 can include other output devices, such as speakers, printers, etc.

The computer 100 can operate in a networked environment using logical connections to one or more remote computers, such as a server computer 146. The server computer 146 can be another personal computer, a server, another type of computer, or a collection of more than one computer communicatively linked together and typically includes many or all the elements described above for the computer 100. The server computer 146 is logically connected to one or more of the computers 100 under any known method of permitting computers to communicate, such as through a local area network (“LAN”) 148, or a wide area network (“WAN”) or the Internet 150. Such networking environments are well known in wired and wireless enterprise-wide computer networks, intranets, extranets, and the Internet. Other embodiments include other types of communication networks, including telecommunications networks, cellular networks, paging networks, and other mobile networks. The server computer 146 may be configured to run server applications 147.

When used in a LAN networking environment, the computer 100 is connected to the LAN 148 through an adapter or network interface 152 (communicatively linked to the bus 106). When used in a WAN networking environment, the computer 100 often includes a modem 154 or other device, such as the network interface 152, for establishing communications over the WAN/Internet 150. The modem 154 may be communicatively linked between the interface 140 and the WAN/Internet 150. In a networked environment, program modules, application programs, or data, or portions thereof, can be stored in the server computer 146. In the depicted embodiments, the computer 100 is communicatively linked to the server computer 146 through the LAN 148 or the WAN/Internet 150 with TCP/IP middle layer network protocols; however, other similar network protocol layers are used in other embodiments. Those skilled in the relevant art will readily recognize that the network connections are only some examples of establishing communication links between computers, and other links may be used, including wireless links.

The server computer 146 is further communicatively linked to a legacy host data system 156 typically through the LAN 148 or the WAN/Internet 150 or other networking configuration such as a direct asynchronous connection (not shown). Other embodiments may support the server computer 146 and the legacy host data system 156 on one computer system by operating all server applications and legacy host data system on the one computer system. The legacy host data system 156 may take the form of a mainframe computer. The legacy host data system 156 is configured to run host applications 158, such as in system memory, and store host data 160 such as business related data.

FIG. 2 schematically shows an interactive business application ecosystem 200 having an interface module 202 in communication with two or more data stores or silos 204 through an enterprise architecture or service oriented architecture (SOA) system 206. The enterprise architecture 202 includes application meta-objects that can be combined and reused to service different business applications. The interactive business application ecosystem 200 permits an end-user of the application to integrate real time changes to create a desired presentation of data from the silos 204 without programming changes being made at a developmental level. The end-user may customize their user interface to present the data from the data silos in a form or manner that works most efficiently for the end-user without having to copy or “screen scrape.” The data sources may be internal, external or both and may be integrated with other enterprise data.

The interface module 202 dynamically converts every data source into XML and then builds a model of the context of all the data elements, referred to herein as “federated data.” The module defines the visualization of the information and the actions that can be performed within the ecosystem 200, thus the interface module 202 operates to create a reusable building blocks of application concepts. In one embodiment, the interface module 202 performs translations and reformatting to produce a Rich Internet Application (RIA) presentation as configured by the end-user according to internal permissions within the ecosystem 200. Thus, the end-user may obtain a view of exactly the data required from each data source without having to independently access each data source and without having to copy data using the virtual screen approach. Advantageously, the ecosystem 200 does not distinguish between run-time and design time so changes on how the data is presented to the end-user may be made in real time by the end-users themselves using menus having drag and drop capability that communicate with the interface module 202.

In one embodiment, the interactive business application ecosystem 200 captures the behavior of the application where subsequent, downstream or post-developed revisions may be made to a user interface viewable by the end-user. By way of example, the end-user may design, modify and the produce a customized user interface for a variety of purposes such as, but not limited to, the presentation of data, increased efficiency in entering and transacting with the data, and other purposes. The end-user's changes are processed through the interface module 202, which in turn modifies metadata as defined by a meta-model system. The ecosystem 200 combines three activities, as follows: (1) application design, (2) application usage, and (3) application administration into one activity and delivers it in the same application environment. In addition, these activities may be restricted with desired permissions, security settings and governance related to the data sources. The ecosystem 200 permits the end-user to make system acceptable changes by identifying and refusing changes that may adversely affect the integrity and behavior of the application. With this approach, changes can be made in the runtime environment by end-users and deployed in real-time. Advantageously, this approach permits application changes initiated by the end user to be done without requiring conventional code development, testing and production. Unlike conventional systems or platforms that provide a clear separation of three activities comprising (1) application design, (2) application usage, and (3) application administration, the ecosystem 200 seamlessly unifies and integrates these activities as describe above. Conventional system inherently builds latency and added cost between development and deployment of application changes, which generally means end users are stuck with static and inefficient user interfaces for receiving, manipulating and viewing data. The ecosystem 200 may advantageously provide a loose coupling between modules or layers within the application, re-usable interfaces, infrastructure insulation, and easy version management of the business application.

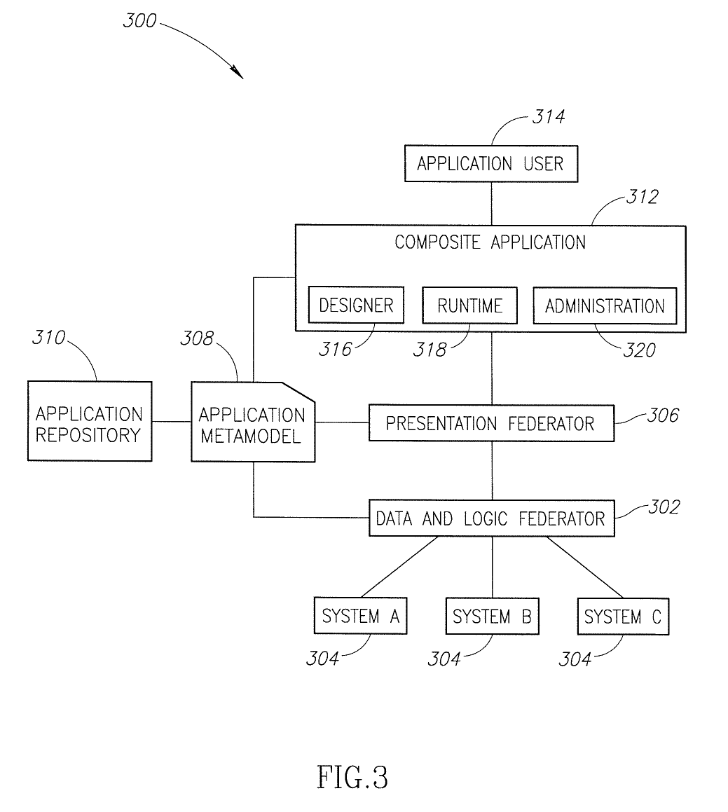

FIG. 3 shows a user interface system 300 having a data and logic federator 302 that combines data and business logic from multiple data sources 304. A presentation federator 306 operates as a composite adaptive interface for the system 300. The presentation federator 306 communicates with an application meta-model 308, which includes the rules of where and how to retrieve the data and how to combine various other rules and instructions. In one embodiment, the application meta-model 308 communicates with an application repository 310 to receive and/or store some of the rules and instructions. The presentation definitions are also defined in the model 308.

The system 300 further utilizes a declarative based composite business application 312 that may be defined to use a combination of data stores while concurrently cooperating with an end-user 314 of the business application. The declarative based composite business application 312 includes a designer module 316, a runtime module 318, and an administration module 320. Each of these modules includes instructions to cooperate with the application meta-model 308 and thus provide an end-to-end representation of the application behavior (i.e., data to presentation). The cooperation between the declarative based composite business application 312 and the application meta-model 308 delivers a mechanism where any part of the application behavior can be modified by the end-user 314 via the declarative based composite business application 312 without requiring code changes. Further the application is inherently adaptive at runtime based on the application environment through which it is delivered.

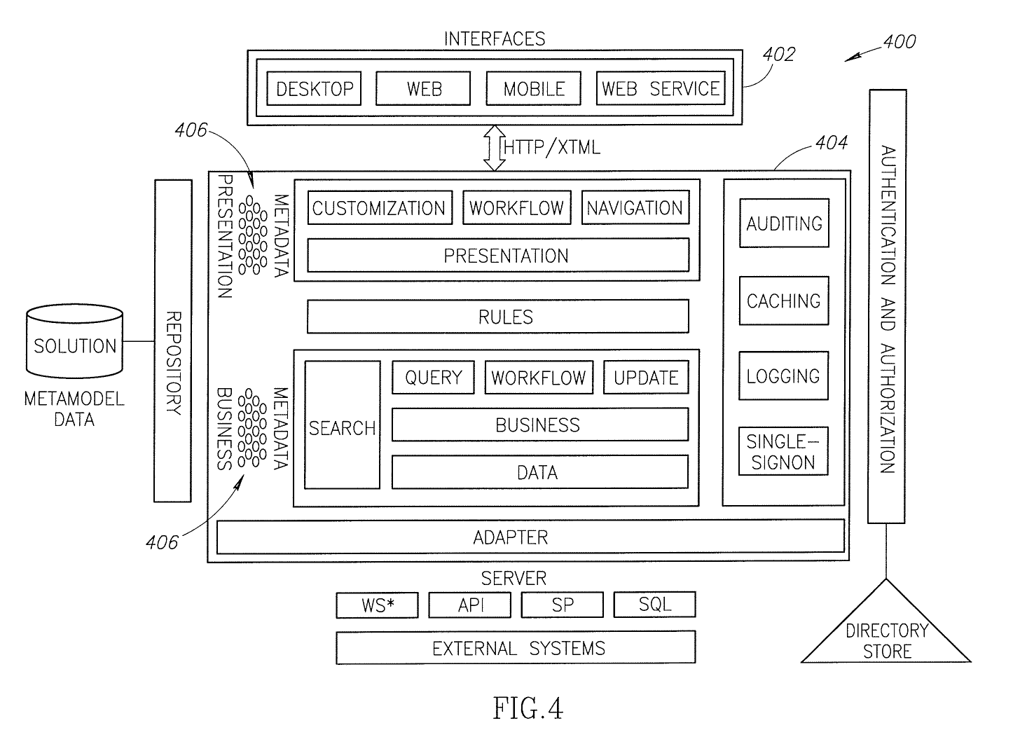

FIG. 4 shows a system 400 having multiple interfaces 402, which may include but are not limited to web, mobile such as a PDA, web services such as a rich internet application (RIA), and so on. The system 400 further includes an enterprise systems interface 404 that includes security and governance features. The enterprise systems interface 404 controls user behavior in the system 400 based on permissions and access given to an individual user. In addition, the interface 404 includes application meta-objects 406 that may take the form of presentation and business meta-data. The presentation metadata represents the visualization aspects and the business meta-data represents the data and rules associated with the meta-objects 406 and permissible user actions.

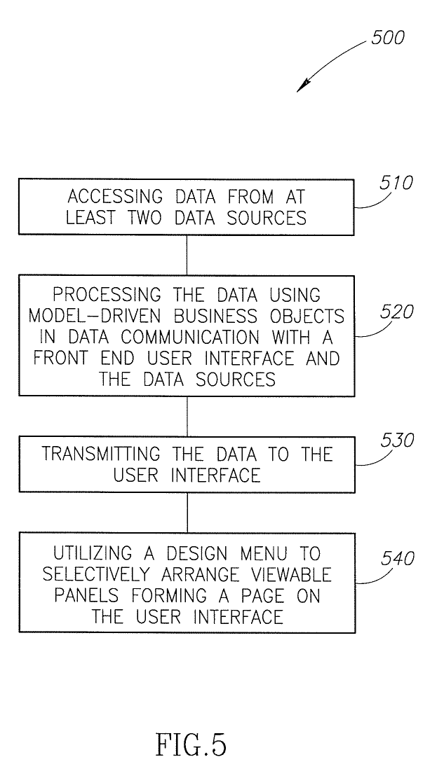

FIG. 5 shows a method 500 for displaying a user interface for a business application to an end-user. At step 510, the method 500 includes accessing data from a back-end data source environment. At step 520, a plurality of model-driven application meta-object software applications in data communication with the back-end data source environment and in data communication with a front-end user interface environment to process the data. At step 530, the processed data is transmitted to the front-end user interface environment of the business application. And at step 540, a design menu accessible by the end user is used to selectively arranging a plurality of application meta-objects viewable on the front-end user interface environment. Each application meta-object includes an amount of data retrievable from the back-end data source environment, wherein selectively arranging the plurality of application meta-objects includes customizing a viewable display of the plurality of application meta-objects to meet a specific need of the end-user without re-designing, re-testing, and re-deploying the business application at a developer level. The invention teaches a method to create a taxonomy of enterprise application functions can be modeled as reusable application meta-objects that can be combined in different ways to deliver business applications for different users—all via a single unified business application platform. Further, the end-user has the ability to create and customize the business application at the same level as a developer in a visual non-coding level.

Aspects of the present invention may advantageously provide a new paradigm for composite business application building. For example, the present invention may provide building blocks or application meta-objects, which encapsulates behavior, visualization, federated data, access to data, actions on the data and security. Further, the application meta-objects may be combined in different ways to create business applications and are reusable so that different application may be created with one platform. The application meta-objects may be customized to be visualized differently by different user groups or modified for different audiences. In one embodiment, the end-users may make changes to the meta-objects that take effect immediately or close thereto. Actions taken by the end-users actions maybe controlled or governed by security encoded within the meta-objects. For example, the security may encapsulate rules to determine valid actions that do not permit damaging or other harmful actions.

A business application ecosystem may advantageously be adapatable through self-learning features that interpret end-user actions and behavior to make the ecosystem more efficient with usage. In one embodiment, the ecosystem may be a model-driven declarative system where the business functions are reusable meta-objects that advantageously overcome existing roadblocks commonly associated with design time, runtime and deployment of software changes in a live environment, which in turn removes the need for application migrations. Because the behavior of a particular business function is in the meta-objects, the end-users are insulated from underlying data source changes and the end-users visual changes do not require software development or upgrade cycles.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined by reference to the claims that follow.

The embodiments of the invention in which an exclusive property or privilege is claimed are defined as follows:

1. A business application platform comprising:
a display system;
a front-end business application environment having a page viewable on the display system;
a back-end business application environment to access data from a plurality of data sources;
a plurality of meta-objects for federating information from the plurality of data sources, the meta-objects having security rules for governing actions initiated within the platform and further having visualization rules for representing data from the data sources to the front end business application environment, the meta-objects disposed between the front-end business application environment and the back-end business application environment, the plurality of meta-objects configured to process an amount of meta-data according to a set of rules, wherein at least some of the meta-data is reconfigurable by a viewer of the display system through a viewer-accessible design menu, the design menu operable by the viewer to customize the first presentation layout into a viewer-desired presentation layout; and
a processor to control the data exchanged from the back-end business application environment through the meta-objects and to the front-end business application environment.

2. The business application platform of claim 1, further comprising a plurality of governance rules operable to restrict the viewer-desired presentation layout according to a set of fixed permissions established within the meta-objects.

3. The business application platform of claim 1, wherein the amount of meta-data includes meta-data to control at least a context, quality and characteristic of the data obtained from the back-end business application environment.

4. The business application platform of claim 1, wherein the amount of meta-data includes meta-data to control at least a context, quality and characteristic of at least the viewer-desired presentation layout.

5. The business application platform of claim 1, wherein the viewer-accessible design menu includes a plurality of drag and drop controls for manipulating the meta-objects through a user interface.

6. The business application platform of claim 1, wherein the plurality of data sources includes at least one data source system that resides externally from the business application platform.

7. The business application platform of claim 1, wherein the plurality of application meta-objects are arrangeable to form an application that permits a plurality of customized windows to be viewable on a display device.

8. The business application platform of claim 1, further comprising an application meta-model that cooperates with the plurality of meta-objects to revise an amount of metadata.

9. The business application platform of claim 1, wherein the plurality of meta-objects are composite application objects for designing, running, and administering metadata within the business application platform.

10. The business application platfonm of claim 1, wherein the plurality of meta-objects are arrangeable to form a page and include normalized data arranged in a custom view by at least one viewer.

11. A method of displaying a user interface for a business application to an end-user, the method comprising:
accessing data from a back-end data source environment utilized by the business application;
processing the data using a plurality of intermediate model-driven application meta-object in data communication with the back-end data source environment and a front-end user interface environment;
transmitting the processed data to the front-end user interface environment of the business application; and
selectively arranging a plurality of application meta-objects viewable on the front-end user interface environment using a design menu accessible by the end user, each application meta-object having an amount of data retrievable from the back-end data source environment, wherein selectively arranging the plurality of application meta-objects includes customizing a viewable display of the plurality of application meta-object s to meet a specific need of the end-user without re-designing, re-testing, and re-deploying the business application at a developer level.

12. The method of claim 11, wherein accessing data from the back-end data source environment includes accessing data from a plurality of external data storage devices.

13. The method of claim 11, further comprising defining meta-data manipulatable by the plurality of intermediate model-driven application meta-object to provide information about the data used by the business application.

14. The method of claim 11, wherein customizing the viewable display of the plurality of application meta-objects to meet the specific need of the end-user includes providing a plurality of application meta-object design options to the end-user through the design menu.

15. The method of claim 11, further comprising maintaining integrity and security of the data in the back-end data source environment through a plurality of governance and security rules.

16. The method of claim 11, further comprising restricting certain actions by the end-user based on permissions encoded into the model-driven application meta-object.

17. The method of claim 11, wherein customizing the viewable display of the plurality of application meta-objects to meet the specific need of the end-user includes modifying the meta-data within the model-driven application meta-object to control at least a context, quality and characteristic of the data.

18. The method of claim 11, further comprising testing the customized viewable display of the plurality of application meta-objects s generated by the end-user.

19. The method of claim 11, further comprising staging the customized viewable display of the plurality of application meta-objects generated by the end-user.

20. The method of claim 11, further comprising fully activating the customized viewable display of the plurality of application meta-objects generated by the end-user into the business application.
